(19) United States
(12) Patent Application Publication
(10) Pub. No.: US 2015/0254261 A1
(43) Pub. Date: Sep. 10, 2015

(54) News Application

(71) Applicant: Guerby Rene, Miami Gardens, FL (US)

(72) Inventor: Guerby Rene, Miami Gardens, FL (US)

(21) Appl. No.: 14/201,833

(22) Filed: Mar. 8, 2014

(51) Int. Cl. G06F 17/30

(52) U.S. Cl. CPC G06F 17/3089

(57) ABSTRACT

A news application where a user can log into an account on a server and submit an article. An article can include text, images, videos, links and other information. The article also has metadata associated with the article. After a user submits an article to the server an analysis of the article is completed. The article is either published or referred to an editor for further review. Readers of the article can comment or vote on the article which affects how likely the article is found in a subsequent search by another reader.

### BACKGROUND OF THE INVENTION

1. Field of the Invention

The present invention relates to online computing, and more particularly, to a news and events related mobile communications application (“app”).

2. Description of the Related Art

Several designs for online news sources have been designed in the past. None of them, however, includes a method and system for gathering, filtering and distribution where users and other sources provide the content for publication.

Numerous online news agencies report news provided by reporters, both staff and freelance, and from wire and other news generating sources. These are generally professional publications in both print and online formats.

Similarly, a variety of news aggregators exist that select and provide the content generated by others. Generally, these services do not employ news story generating reporters. Instead, they comb through reports from other publications and present news stories their editors select to republish or link to. Often the overall content of the news aggregator targets an audience for a particular type of story. For example, some may lean towards a particular political bent, have locally relevant content or serve a peculiar subset of the community.

Yet other news providers specialize in gossip and related material submitted by a variety of collection sources both commercially available and privately obtained. This category can also contain, pejoratively, tabloids and similar publications.

Commonly used methods of news distribution and some other patents describe the relevant subject matter and provide for a number of more or less complicated features that fail to solve the problem in an efficient and economical way. None of these patents suggest the novel features of the present invention.

### SUMMARY OF THE INVENTION

It is one of the main objects of the present invention to provide a public based news collection and distribution method and system.

It is another object of this invention to provide a highly relevant, current and efficient method and system.

It is still another object of the present invention to provide a method and system that is policed by users and the community at large and takes the news selection duty from the hands of the professional editor and delivers it to the people.

It is yet another object of this invention to provide such a methods and system that is inexpensive to distribute and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 is a flow chart of an example of a process.

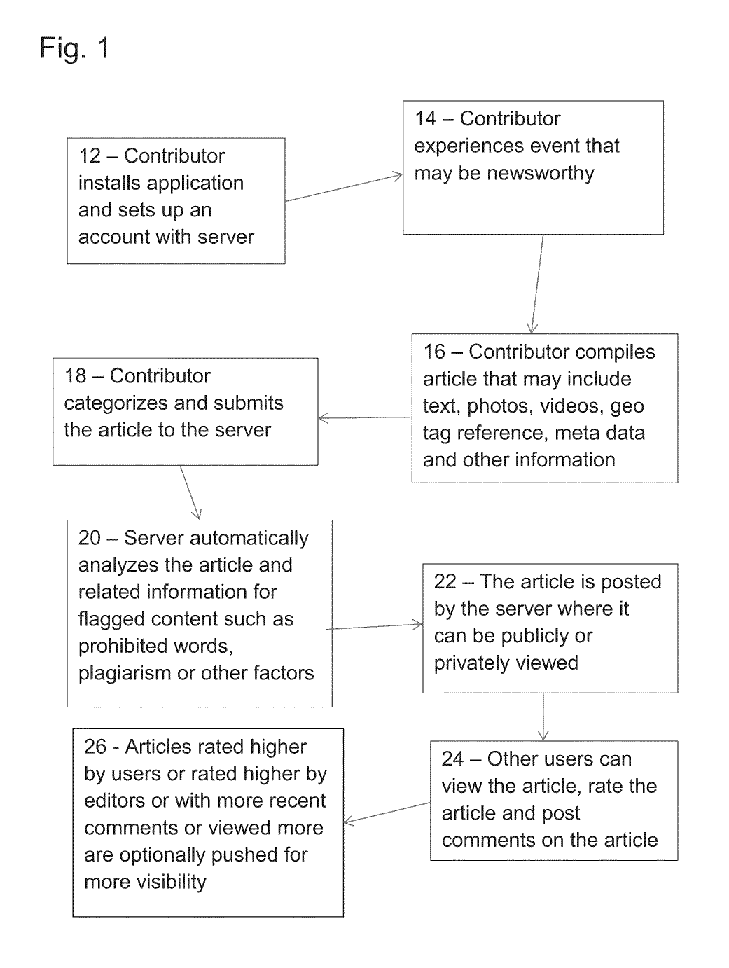

FIG. 2 shows a screen shot on a mobile device of a log in screen.

FIG. 3 shows a screen shot on a mobile device an example of a main menu.

FIG. 4 shows a screen shot on a mobile device of a sample search interface.

FIG. 5 shows a screen shot on a mobile device where a user can create a new article.

FIG. 6 shows a screen shot on a mobile device showing a displayed article.

### DETAILED DESCRIPTION OF THE PREFERRED EMBODIMENT

News and news distribution has traditionally been in the hands and under control by a very limited number of people who are in control of the outlets. These outlets have been commonly television news, newspapers and more recently online content providers.

Part of the control of the news being in the hands of the few stems from the fact that news organizations have their own reporters, contract or freelance reporters and access to professional news sharing organizations from around the globe.

The world is undergoing a fundamental change of technology where nearly everyone has a mobile computing device. Often these are characterized in the form of a phone with internet connectivity. Most phones now also have at least one still image camera and a video capture means with audio built into a single device. Some devices such as tablets, handheld devices, mobile computers and to some degree desktop computers also include these features that are compatible with the presently described system and method.

Today, anyone can find themselves in the presence of an event with noteworthy or newsworthy qualities. It is easy to capture and retain events and the aftermath in a split second and while still highly relevant to the rest of the community.

With technology in the hands of the masses to capture and record events around them what is needed is a way to gather, organize, filter and distribute this content in a manageable way.

Referring now to the drawings, where the present invention is generally shown in the drawings, it can be observed that it basically is comprised of a system utilizing a mobile handheld device, such as a smart phone or tablet that interacts with a centralized server.

In this context, the term server in intended to encompass the hardware and software that comprise the computing power of system that is organizing the invention as disclosed herein. It also may encompass the business or legal entity that controls that hardware and software for the desired effect.

The server manages user accounts and preferably has a storage capability to store user information, articles and supporting documents such as photos, video, geo tag information, ratings, reviews and other relevant information to the system. In step 12 a contributor installs the news application onto their computing device.

A contributor is generally anyone who wants to interact with the server with more permission than a mere reader of the news. A contributor could also be referred to as an end user, a user, a reporter, a news gatherer, a contributor, a freelancer, a writer or a similar compatible term as contrasted to only a reader.

Similar to other online systems, a contributor may establish an account with the server accessed by a secure and uniquely identifying means to gain access to privileges associated with their account on the server. In another variation the access could be completely anonymous to protect the identity of the contributor. In some instances this may be inconsequential if false personal information is used to establish an account with the server system.

In some versions of the present design there are protocols required to establish an account and to verify the true identity of the contributor. By having the contributor identity known there may be a reduced incidence of sniping, defamation, false reporting and other abuses that may be more prevalent with anonymity.

The process continues at step 14 when a potentially noteworthy or newsworthy event or part of an event occurs in the presence of the contributor. The contributor is therefore a witness and can relay the experience to others through the written word, spoken recording, captured photo or video evidence or other method by which human to human communication may customarily occur in a news or online internet type of setting.

Often, there will be multiple forms of media in any type of article. In step 16 the contributor compiles an article from any type of information that they may have. This can take a form as simple as a single photo, audio or video recording. As the compiler desires the article can become more complex with, for example, captions on photos, subtitling video, including geographic reference, facial tags or other commentary. Of course a written word article is a common form that many readers may prefer to provide some more insight into both the event and the contributor to evaluate the credibility of the source.

The contributor may also add tags or other metadata to aid in categorizing and searching through the article. For example, key names, places or events may act as primary key words. The tags may be visible or may be hidden from a reader.

By way of a specific example, if a contributor witnesses a celebrity being arrested at a club they may provide a photo with comments. Tags could include the name of the celebrity, name of the club, city or other place where the incident occurred or other information that the contributor anticipates that could be important relevant search terms of critical details of the event.

In step 18 the contributor categorizes the article and submits the article to the server. The types of categories are potentially endless. For example, but by no means to limit the types of categories, classifications could include politics, celebrity, sports, local, international, crime, lifestyle, technology or the like.

By step 20 the article has been received by the server from the contributor. Prior to publishing the article the server can optionally review the article for predetermined issues. For example, certain words or phrases can be flagged for content purposes. Obviously, some words with prejudicial connotations or having an inflammatory effect may be discovered by the server.

Other analysis by the server could include scanning for non-original content or portions of the contributor's article that may not be original can be flagged for further review. This can indicate plagiarism, unauthorized duplication of another's work or could be something more innocent, such as fair use quotes, portions used for commentary or discussion or other permissible uses.

The images and/or video content uploaded to the server by the contributor can also be analyzed for improper content, as determined by the server. Images may be inflammatory or may be restricted under copyright or other laws. Optionally, this automatic review of content is included in the server's capabilities and can happen at any point in the process, preferably prior to publishing.

In some versions of the present design there may be human editorial effort applied to articles and elements of articles prior to publishing. This could be applied to the entire article or alternatively could occur only on system flagged items. Any article that meets a certain threshold of reader objection or comment can also be a trigger for more actual human scrutiny by an editor of the server or other suitable means to better and more thoroughly evaluate and act on issues with an article that may rise to such importance.

If the basic and automatic checks on the content of the articles appear to indicate that the article is suitable for publishing, then the article is posted by the server in step 22 where the article and related content is publicly searchable and visible by the audience.

There are potentially public articles that are openly visible by anyone and private articles that have limited access. Private articles, or articles with restrictions on viewing, may be designated as such by the server or the contributor. Examples of when a private setting may be effectively employed could include articles of limited interest, of particularly sensitive material or private to a selected group.

By way of a specific example, a limited access article could be used when the subject is about a family event. In this case, family events are preferred to be accessible by only those who are members of the family. This could equally apply to classes of readers such as employees of a particular business, members of a club or organization or any other definable class.

When an article is restricted in access to a specific group, access may be granted by password or other unique key. Alternatively, this could be available to users logged in to an account with the server or other verifying system (i.e. an external account at a social network or business entity). Yet another means could be by a specific invitation to an individual or group that has been identified by wither the server or designated by the contributor.

In step 24 feedback is available regarding the article. The feedback could include comments, flags, commentary, additional information like tags, geographic information or any other information that could enhance the article or the users' experience.

With more people acting as contributors the volume of articles could be large. Similarly, the readers may have limited time to devote to reading the articles. Therefore a form of ranking content may become necessary to aid the user in locating relevant and appropriate content to enhance the user experience.

In step 26 articles can be ranked higher or lower by users and/or by editors. Some factors that may affect ranking of an article could be, for example, the number of times the article was delivered to a reader, a voting system or subjective ranking by an editor. The more popular articles are generally promoted or pushed to be more accessible to the readers and visible in search results or suggestions made by the server for a particular user or class of user.

For example, people from a specific city might be more interested in news that mentions the name of that city or has been tagged relevant to that city. Therefore, anyone who searches from that city, as identified by the requesting IP address, is more likely to find articles about that city of interest.

Similarly, prior interest in an article having a specific key word or tag could signal a higher likelihood in a subsequent article having a similar value to a reader. Other sociological factors or metrics collected by the server or other source can be used to enhance the readers experience by promoting articles that have some indicia of increased likelihood to interest a particular person.

The articles can each have a rating metric provided by earlier readers, editors or computer generated rating system. Generally, an article of interest to many readers could have a greater interest from other readers. An editor endorsed and rated article can likewise have qualified that other readers are likely to value.

With multiple means of measuring an article, such as described above, the server has the ability to tweak and alter the weight that any particular measure is given. Some users may be different than other users as well. In this case the weight give to metrics for one user may be different than another user and each user is then provided a result that is tailored to their reading and searching habits or preferences. This can be done in a settings control manually or can be done on a more global and automatic scale by the server.

In some cases multiple contributors will make submissions based on the same event. Articles on the same topic can be linked or grouped together. Sometimes a story has two sides and therefore contrasting views can be useful for a reader to analyze the reality behind any subjective rendering of the facts.

A rating indicator can allow readers to more easily sort through similar articles or otherwise provide a more efficient navigation means. For example, there could be a number ranking like ninety-five out of a hundred or four stars out of five. Another example could be a number of endorsements like two hundred readers have viewed this article.

Other markers helpful to the reader could be identification as to whether the article was posted by an outside news source, similar to those used by traditional newspapers or an average person on the street. For example, one color screen trim or other visual indicator could signal that it is a professionally produced article while another color or signal shows that it came from a layman witness.

Of course, in addition to the articles provided by users of the system and server, there can be other content provided from a wide variety of commercially or freely available resources. In this sense, the system can be partially a news aggregator. The other enhancements as to ranking, commenting and searching can be applied to any of the articles, regardless of the source.

Referring now to figures two through six where some examples of screen shots are demonstrated as mere enabling examples. These examples are not intended to be exhaustive or specific but are instead provided as a base for how some features may be oriented. The form is intended to change from time to time and also to be customizable by the user. This can be both for layout, orientation, colors and available features. The look and feel of the interface can also change from device to device.

For example, as the screen size varies from mobile devices such as tablets, phones, wearable displays and other types of monitors, the preferred layout can be amended. This can be automatically detected by the server to provide a recommended optimal viewing experience and can also, optionally, be configured by the reader or contributor as to their own preferences.

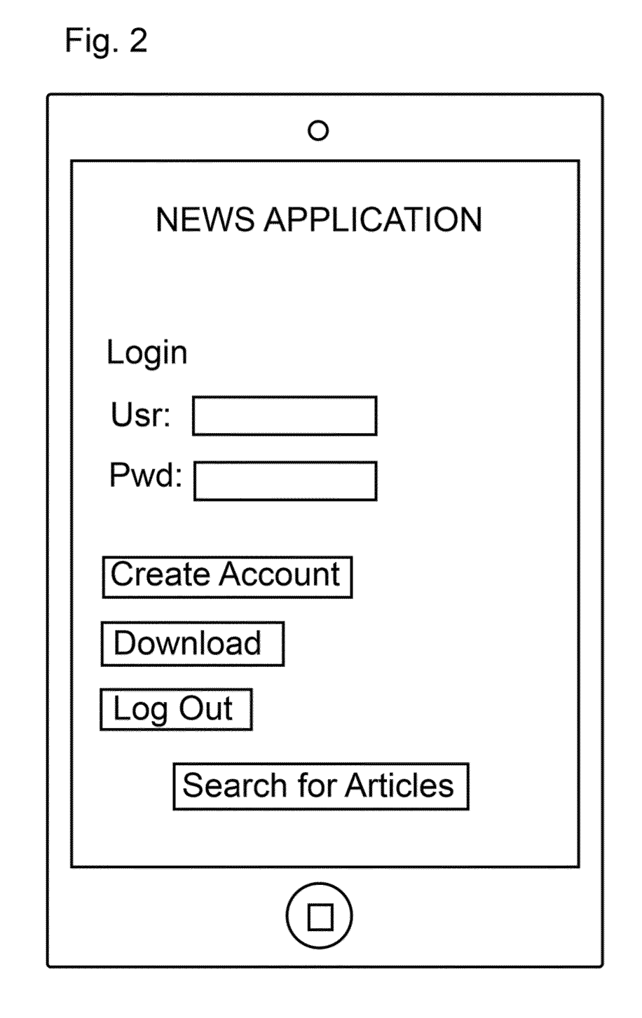

FIG. 2 is an example of a log in screen. The reader or contributor can enter login credentials, create a new account, download a user application for enhanced operability of the system, log out or enter the system anonymously to search for articles without uniquely identifying themselves to the system.

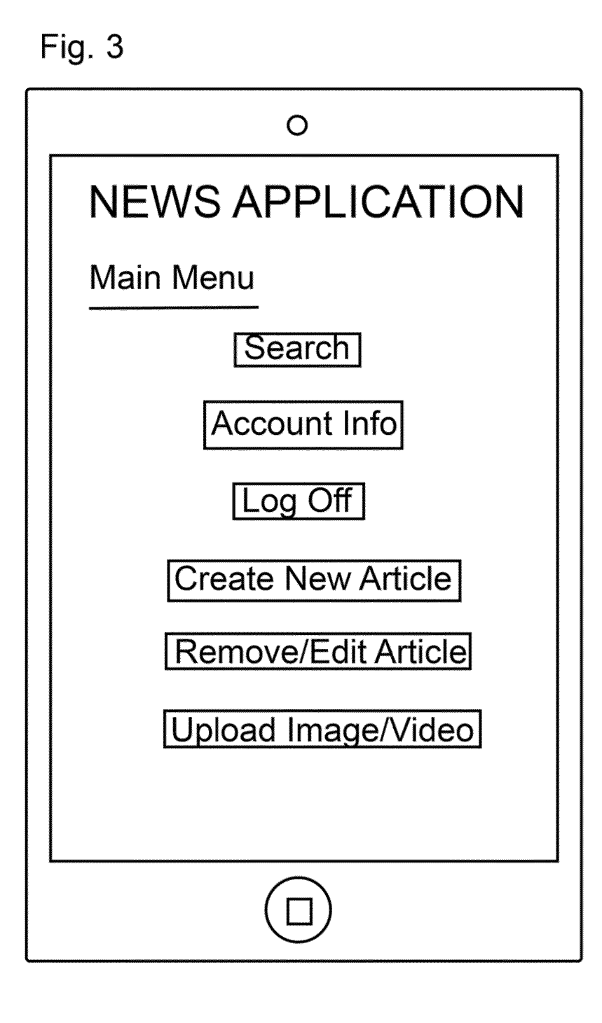

FIG. 3 is a sample screen that could be visible after a registered user logs into the server system. Buttons may be available to perform such tasks as searching for articles, authors, ratings and other search criteria, examining and amending account information, logging off the server, creating a new article by submitting new content, removing or editing an existing article and/or uploading images, video or other content to a contributors account in anticipation of incorporating those items into an article for contribution.

Each button on this example is modifiable and moveable. In some configuration or for some users it may be preferable to orient these buttons in a different way or have different buttons to link directly to other screens to allow for a customizable and dynamic system to aid any user in easy and efficient navigation.

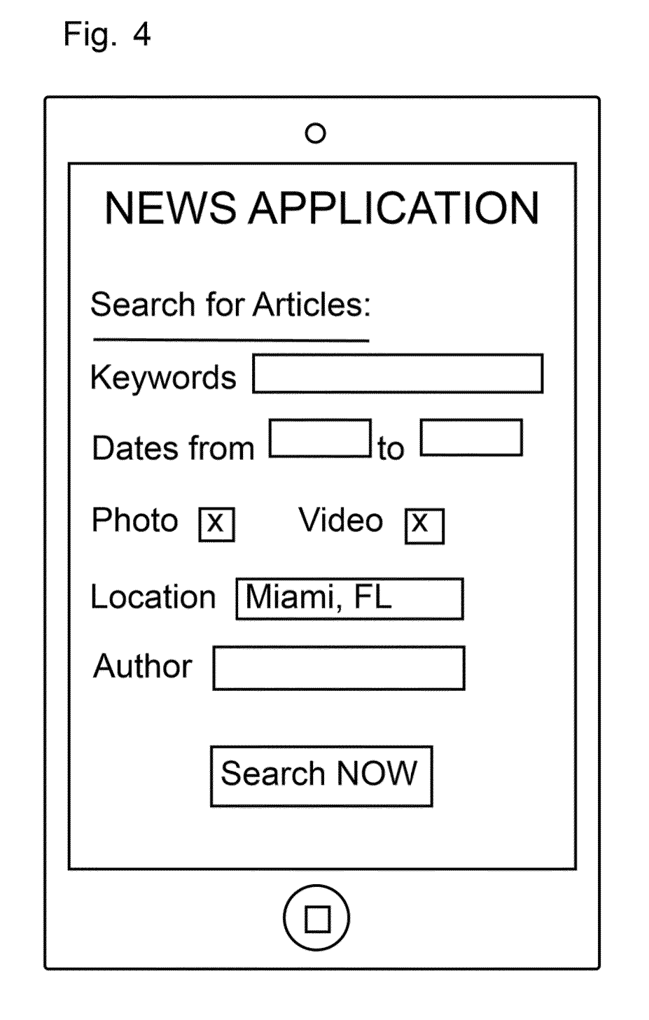

FIG. 4 is another sample configuration for a search screen. In this example the searcher can look for specific keywords, dates that an article was published, whether there is video or photo content included with an article, a location identified to provide more geographically relevant content and an author. A search now button is provided to initiate a search of published content. Of course, these features and buttons may also be reconfigurable to another format or to customize the content of the page as desired.

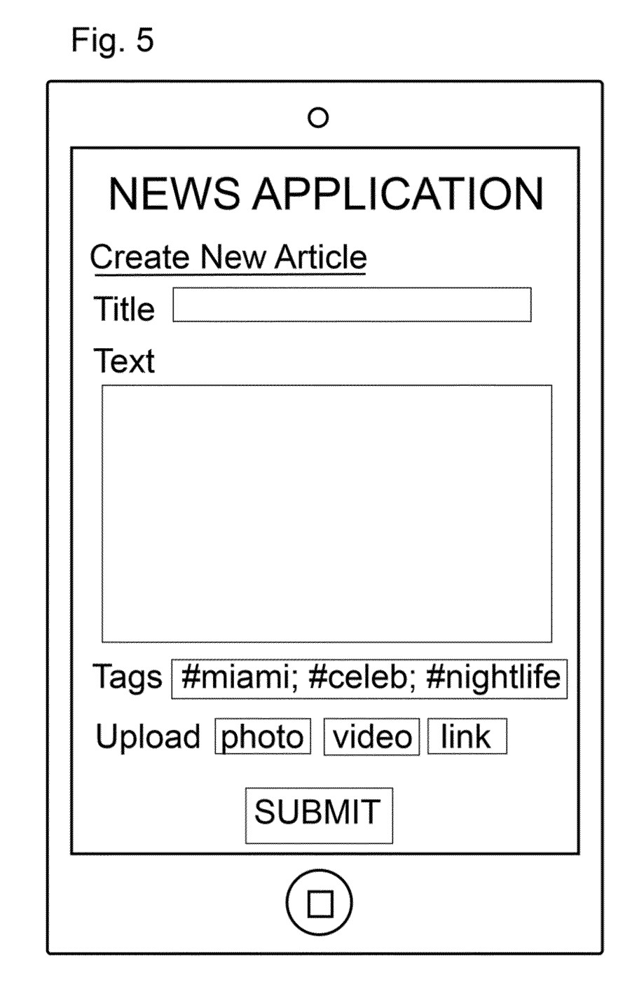

FIG. 5 is a sample of a screenshot of what might be seen by a contributor when composing an article prior to uploading it to the server for distribution. A similar screen could also be used for amending or editing an article. Of course this screen as well could be amended and customized as necessary to provide relevant features at the fingertip of the contributor.

In this example a title of the article is called for as well as any written textual content. Tag or keywords are identified as considered by the contributor. In this case the article is believed to be most relevant to celebrity and nightlife and Miami. An option to combine the written word with photos, video or other media by link is also available. Once the contributor is satisfied with the content of the contribution then they can submit the article to the server.

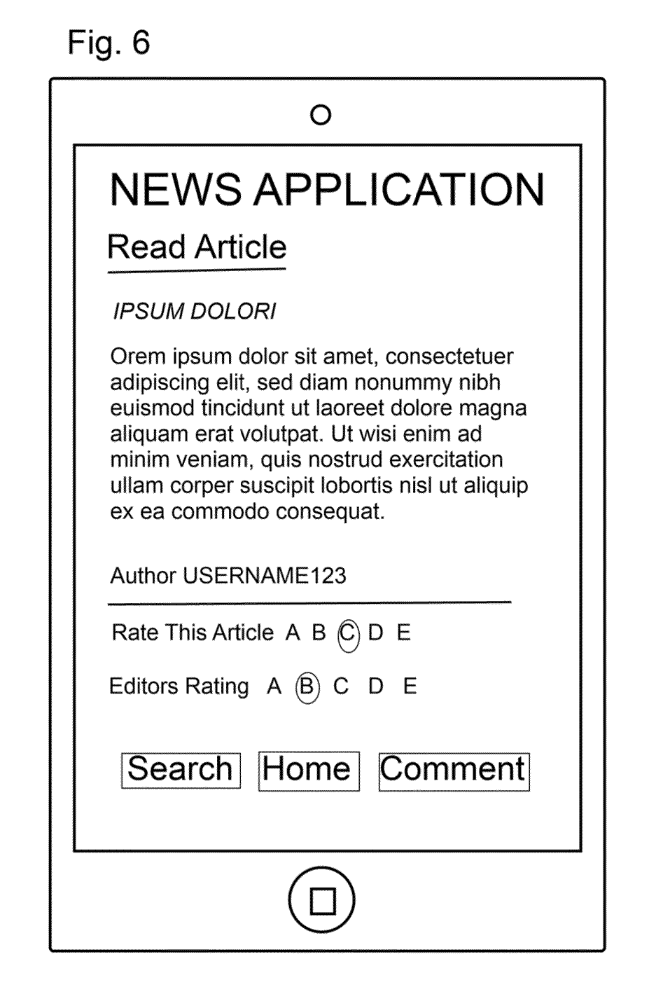

FIG. 6 is what a user might see in one example of a screen shot. An article is shown to include the text but can also include other attachments such as photos or video. The author is optionally identified. An example of a rating system is visible. In this rating system example one can see that an editor has rated the article a B and other readers have rated it a C. The reader can click on another rating if they would like to contribute their opinion to the survey.

Buttons that may be useful to the reader are also handily displayed. In this case a search button, link to go to a home page or a link to comment on the present article is available. Obviously, depending on the context and user setting there could be other buttons present or removed or other content made available.

A version of a news application can be fairly described as being comprised of a computing device, such as mobile phone, tablet or other computer and a remotely located server. The computing device and server each has a processor, memory and internet connectivity and are thus fully functional computing devices. A contributor connects over the internet to the server and may be uniquely identified by the server. In some versions all contributor contact is anonymous and no unique identifiers are ever used. In yet other versions a unique identifier is used but that information cannot be used to identify the specific individual, such as merely a serial number not associated with the name of a person. The contributor creates an article including at least one metadata. Often the article is based on a unique personal experience or research. Metadata is included to help categorize the article for indexing and searching. Typically the metadata could be selected from any one or more of: a geotag (or other data to associate a location relevant to the article), a subject, an image, a video, a writing, a link, a title, a subject tag or any other data that may be relevant to indexing. Once written and/or compiled, the contributor uploads and stores the article and metadata on the server. The server analyzes the article and the metadata for a first criteria that could be, for example, selected from any of: offensive content, plagiarism, non-original content or duplicative content. Basically, this is an automated analysis to flag an article that may not be appropriate for dissemination or for other reasons the server (and the humans that control the server) may not want to publish automatically at that time. If the first criteria is positive then the article is referred to an editor, meaning that it was flagged for further review prior to being made available to others. The editor may be a human editor or may be a further automated process. If the first criteria is negative then the article is made publicly available by the server without further review by a human. The article may at any other time be reviewed by a human or the server if designated. Once published, a first reader accesses in a viewable form the article from the server and any or some of the related meta data or other related content. The first reader assigns a second criteria to the article, for example the second criteria could selected from any of: a rating, an endorsement or a comment. Generally, the second criteria is some feedback from a reader that may help index, control content, flag or other action that could help the server become more efficient or that could help subsequent users. The second criteria affects the probability of whether the article will be found in a search on the server by a second reader. For example, a higher rated or a more viewed article may organically rise towards the top of a search performed by another reader. A third or other subsequent reader anonymously (or if registered maybe not anonymously) reads any article made publicly available by the server. A fourth reader anonymously searches through articles made publicly available by the server using any combination of the metadata, first criteria, second criteria or any other means designated by the server and not specifically limited out here.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A news application comprising a computing device comprising and a server;
the computing device and server each having a processor, memory and internet connectivity;
a contributor connects over the internet to the server and is uniquely identified by the server;
the contributor creates an article including at least one metadata;
the metadata selected from any of: a geotag, a subject, an image, a video, a writing, a link, a title or a subject tag;
the contributor uploads and stores the article and metadata on the server;
the server analyzes the article and the metadata for a first criteria;
if the first criteria is positive then the article is referred to an editor;
if the first criteria is negative then the article is made publicly available by the server without further review by a human;
a first reader accesses in a viewable form the article from the server;
the first reader assigns a second criteria to the article;
the second criteria affects the probability of whether the article will be found in a search on the server by a second reader;
a third reader anonymously reads any article made publicly available by the server;
a fourth reader anonymously searches through articles made publicly available by the server using any combination of the metadata, first criteria or second criteria.

2. A news application as disclosed in claim 1 further characterized in that the first criteria is selected from any of: offensive content, plagiarism, non-original content or duplicative content.

3. A news application as disclosed in claim 1 further characterized in that the second criteria is selected from any of: a rating, an endorsement or a comment.

4. A news application as disclosed in claim 1 further characterized in that the editor is a human.

5. A news application comprising a computing device comprising and a server;
the computing device and server each having a processor, memory and internet connectivity;
a contributor connects over the internet to the server and is uniquely identified by the server;
the contributor creates an article including at least one metadata;
the metadata selected from any of: a geotag, a subject, an image, a video, a writing, a link, a title or a subject tag;
the contributor uploads and stores the article and metadata on the server;
the server analyzes the article and the metadata for a first criteria;
if the first criteria is positive then the article is referred to an editor;
the editor is a human;
if the first criteria is negative then the article is made publicly available by the server without further review by a human;
a first reader accesses in a viewable form the article from the server;
the first criteria is selected from any of: offensive content, plagiarism, non-original content or duplicative content;
the first reader assigns a second criteria to the article;
the second criteria is selected from any of: a rating, an endorsement or a comment;
the second criteria affects the probability of whether the article will be found in a search on the server by a second reader;
a third reader anonymously reads any article made publicly available by the server;
a fourth reader anonymously searches through articles made publicly available by the server using any combination of the metadata, first criteria or second criteria.
